(19) United States
(12) Patent Application Publication
(10) Pub. No.: US 2024/0162407 A1
(43) Pub. Date: May 16, 2024

(54) ELECTRODE COATING DEVICE

(71) Applicant: SK On Co., Ltd., Seoul (KR)

(72) Inventors: Hong Sik KIM, Daejeon (KR); Jang Hoon OCK, Daejeon (KR); Yoon Jae YIM, Daejeon (KR); Byung Chan KANG, Daejeon (KR)

(21) Appl. No.: 18/469,553

(22) Filed: Sep. 19, 2023

(30) Foreign Application Priority Data
Nov. 10, 2022 (KR) 10-2022-0149772

(51) Int. Cl. H01M 4/04; B05C 5/02

(52) U.S. Cl. CPC H01M 4/0404; B05C 5/0241; B05C 5/0262

(57) ABSTRACT

An electrode coating device includes a die block including a first die and a second die coupled to each other, and at least one of the first die and the second die having an accommodating portion for accommodating slurry, a shim plate partially disposed along a circumference of the accommodating portion between the first die and the second die to form a discharge port through which the slurry is discharged, and an expansion plate coupled to the shim plate, wherein the shim plate includes: a first section, second sections, and a third section, wherein the expansion plate is disposed in a form expanding a width of the third section in a region corresponding to the accommodating portion.

### CROSS-REFERENCE TO RELATED APPLICATION(S)

This patent document claims the priority and benefits of Korean Patent Application No. 10-2022-0149772 filed on Nov. 10, 2022, the disclosure of which is incorporated herein by reference in its entirety.

### TECHNICAL FIELD

Present disclosure relates to an electrode coating device capable of reducing a thickness variation of a slurry.

### BACKGROUND

A secondary battery has a structure including an electrode assembly having a structure in which a positive electrode, a negative electrode, and a separator interposed between the positive electrode and the negative electrode, and the positive electrode and the negative electrode are formed by applying a slurry including an active material to a current collector formed of a metal foil or the like. Here, the slurry needs to be formed to have a uniform thickness on the current collector in order to make the characteristics of the secondary battery uniform, and to this end, an electrode coating device, such as a die coater, is used.

Such an electrode coating device includes a slot die formed to be elongated in one direction so that the slurry may be relatively thinly applied over a wide area.

The slot die allows a coating liquid to be discharged through a gap (a slot) at the end of the electrode coating device divided into two parts, like ink coming out of the tip of the nib of a fountain pen, thereby applying the slurry to the current collector, while the electrode coating device itself is moving or the current collector is moving. Since the coating method using such an electrode coating device is superior to other coating methods in terms of maintenance and productivity, the coating method has also been widely used for panel manufacturing of flat panel display devices, as well as applying the slurry to the current collector of the secondary battery electrode.

However, even with the electrode coating device, variations in the thickness of the slurry applied to the current collector may occur, and this problem is further aggravated when the slurry is applied to multiple regions using a single electrode coating device.

### SUMMARY

Present disclosure may be implemented in some embodiments to provide an electrode coating device capable of reducing a thickness variation of a slurry applied to a current collector.

In some embodiments of the present disclosure, an electrode coating device includes: a die block including a first die and a second die coupled to each other, and at least one of the first die and the second die having an accommodating portion for accommodating slurry; a shim plate partially disposed along a circumference of the accommodating portion between the first die and the second die to form a discharge port through which the slurry is discharged; and an expansion plate coupled to the shim plate, wherein the shim plate includes: a first section disposed on the opposite side of the discharge port; second sections extending from both ends of the first section toward the discharge port; and a third section extending from a center of the first section toward the discharge port to divide the discharge port into a first discharge port and a second discharge port, wherein the expansion plate is disposed in a form expanding a width of the third section in a region corresponding to the accommodating portion.

In some embodiments of the present disclosure, the expansion plate may be disposed on both sides of the third section.

In some embodiments of the present disclosure, the expansion plate may be formed of a square plate and may be disposed such that one side thereof is in contact with the first section.

In some embodiments of the present disclosure, the expansion plate may be disposed to be spaced apart from the discharge port by 4 mm or less.

In some embodiments of the present disclosure, the expansion plate may be formed such that a length of the one side is in a range of 5 mm to 30 mm.

In some embodiments of the present disclosure, the electrode coating device may further include: a supply port formed through the die block and used as a path for supplying the slurry to the accommodating portion, wherein the third section is disposed to face the supply port.

In some embodiments of the present disclosure, the expansion plate may include a flow control portion disposed outside the shim plate and a coupling portion extending from the flow control portion and overlapping the shim plate, the coupling portion may include at least one first groove portion and at least one first protrusion portion, and the shim plate may include at least one second protrusion portion inserted into the at least one first groove portion and at least one second groove portion into which the at least one first protrusion portion is inserted.

The expansion plate may be detachably coupled to the shim plate.

In some embodiments of the present disclosure, the flow control portion may be disposed on both sides of the third section, and the coupling portion may connect the two flow control portions and may be coupled to the third section.

In some embodiments of the present disclosure, an electrode coating device include: a die block including a first die and a second die coupled to each other, and at least one of the first die and the second die having an accommodating portion for accommodating slurry; a shim plate partially disposed along a circumference of the accommodating portion between the first die and the second die to form a discharge port through which the slurry is discharged; and an expansion plate coupled to the shim plate, wherein the shim plate includes: a first section disposed on the opposite side of the discharge port; and a second section and a third section extending from the first section toward the discharge port, respectively, and the expansion plate is disposed in a form of reducing a space between the second section and the third section in a region corresponding to the accommodating portion.

In some embodiments of the present disclosure, the electrode coating device may further include: a supply port formed through the die block and used as a path for supplying the slurry to the accommodating portion, wherein the third section is disposed to face the supply port, and the expansion plate is disposed to be in contact with the third section.

### BRIEF DESCRIPTION OF DRAWINGS

Certain aspects, features, and advantages of the present disclosure are illustrated by the following detailed description with reference to the accompanying drawings.

FIG. 1 is a perspective view schematically illustrating an electrode coating device according to an embodiment of the present disclosure.

FIG. 2 is an exploded perspective view of the electrode coating device illustrated in FIG. 1.

FIG. 3 is a plan view taken along line ‘I-I’ of FIG. 2.

FIG. 4 is a cross-sectional view taken along line II-II′ of FIG. 1.

FIG. 5 is a partial cross-sectional view of an electrode coating device according to another embodiment of the present disclosure.

FIG. 6 is an exploded perspective view of the electrode coating device illustrated in FIG. 5.

FIG. 7 is a perspective view of an electrode coating device according to another embodiment of the present disclosure.

FIG. 8 is an exploded perspective view of the electrode coating device illustrated in FIG. 7.

### DETAILED DESCRIPTION

Embodiments of the present disclosure will be more fully described below with reference to the accompanying drawings, in which like symbols indicate like elements throughout the drawings, and embodiments are illustrated. However, embodiments of the claims may be implemented in many different forms and are not limited to the embodiments described herein. The examples given herein are non-limiting and only examples among other possible examples.

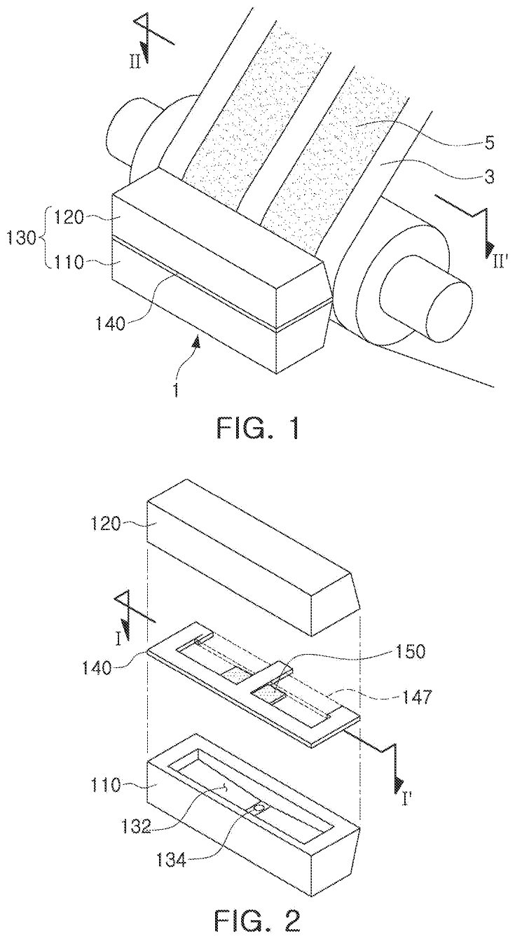

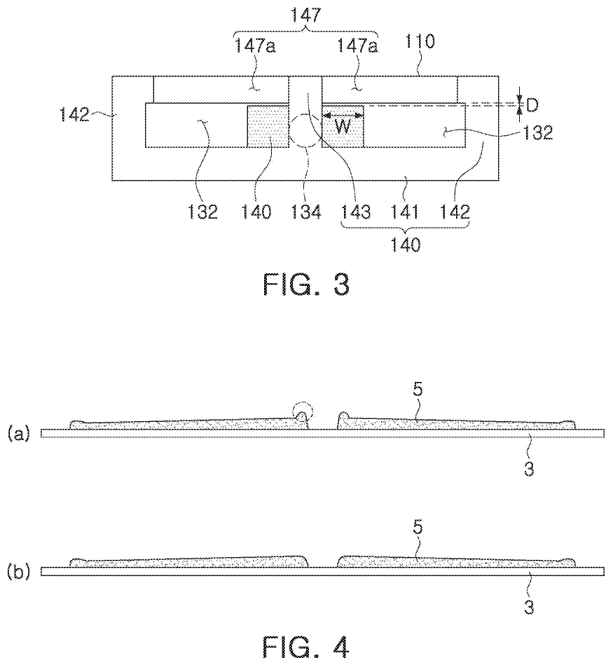

FIG. 1 is a perspective view schematically illustrating an electrode coating device according to an embodiment of the present disclosure, FIG. 2 is an exploded perspective view of the electrode coating device illustrated in FIG. 1, and FIG. 3 is a plan view taken along line I-I′ of FIG. 2.

Referring to FIGS. 1 to 3, an electrode coating device 1 according to the present embodiment may include a die block 130 including a first die 110 and a second die 120 and a shim plate 140 located between the first die 110 and the second die 120 may.

The first die 110 and the second die 120 may be formed in similar shapes and may be arranged in a vertical direction and coupled to each other.

A groove portion-shaped accommodating portion 132 may be formed inside at least one of the first die 110 and the second die. The accommodating portion 132 may be formed as a space for accommodating an electrode mixture (hereinafter, slurry).

A supply port 134, which is a path through which a slurry 5 is supplied to the accommodating portion 132, may be connected to the accommodating portion 132. The supply port 134 may be formed in the form of a hole passing through at least one of the first die 110 and the second die 120, one end thereof may be connected to the accommodating portion 132 and the other end thereof may be formed on the outside of the die block 130 and connected to a device for supplying slurry.

In the present embodiment, one supply port 134 is connected to a longitudinal center of the accommodating portion 132. However, the present disclosure is not limited thereto, and various modifications may be made, such as configuring a plurality of supply ports 134 to be spaced apart and connected to the accommodating portion 132.

The shim plate 140 may be formed of a thin plate-like member, and may be partially disposed along the circumference of the accommodating portion 132 between the first die 110 and the second die 120 to form a discharge port 147 through which the slurry accommodated in the accommodating portion 132 is discharged.

The shim plate 140 may be interposed between the first die 110 and the second die 120 to form a gap between the first die 110 and the second die 120. This gap may be used as the discharge port 147 through which the slurry accommodated in the accommodating portion 132 is discharged to the outside of the electrode coating device 1. Accordingly, a thickness of the shim plate 140 may define a size of the gap of the discharge port 147. In the present embodiment, the shim plate 140 may be formed to have a thickness of 0.5 mm to 1 mm, but is not limited thereto. The electrode coating device 1 may discharge the slurry 5 to a metal foil, a current collector 3, through the discharge port 147. The discharge port 147 may be formed to have a thin and wide slit shape so that the slurry 5 spreads and is coated on the current collector 3.

The shim plate 140 may be disposed so that the slurry does not leak to a crack between the die blocks 130, except for a region in which the discharge port 147 is formed, and may also function as a gasket. Accordingly, the shim plate 140 may be formed of a material capable of sealing between the first die 110 and the second die 120.

Specifically, the shim plate 140 may surround the accommodating portion 132 and may be formed in a form in which only a portion in which the discharge port 147 is formed is removed. When the accommodating portion 132 is formed in the first die 110 as in the present embodiment, an upper surface of the first die 110 may be formed in a quadrangular ring shape along the circumference of the accommodating portion 132. In this case, the shim plate 140 may be formed to have a shape corresponding to the above quadrangular ring shape, but may be partially open.

For example, the shim plate 140 may include a first section 141 disposed on the opposite side of the discharge port 147 and second sections 142 extending from both ends of the first section 141 toward the discharge port 147. The second sections 142 may extend in a direction, perpendicular to the first section 141.

A width of the end of the second section 142 may be partially expanded. In the present embodiment, the discharge port 147 may be formed as a space between the ends of the second sections 142, and the end of the second section 142 may be expanded in a form of reducing the size of the discharge port 147. At this time, the portion in which the width of the second section 142 is expanded may be expanded only to the periphery of the accommodating portion 132 without covering the accommodating portion 132. Therefore, the shim plate 140 of the present embodiment may be disposed not to overlap the accommodating portion 132 except for a third section 143 described below.

In the present embodiment, the discharge port 147 may be defined as a space formed by the portion of the second sections 142 having an expanded width, the first die 110, and the second die 120.

In addition, as illustrated in FIG. 1, the electrode coating device 1 of the present embodiment divides the discharge port 147 into at least two regions and applies the slurry 5 to the metal foil as the current collector 3. To this end, the shim plate 140 of the present embodiment may include the third section 143 for dividing the discharge port 147 into two regions.

The third section 143 may extend from the center of the first section 141 toward the discharge port 147 and may be disposed parallel to the second sections 142. Here, the center of the first section 141 may refer to an arbitrary point of the first section 141 disposed between the second sections 142.

In the present embodiment, since only one third section 143 is provided, the overall shape of the shim plate 140 may be similar to ‘E.’ However, it is also possible to include a plurality of third sections 143 as needed.

As the shim plate 140 of the present embodiment includes the third section 143, the discharge port 147 may be divided into a first discharge port 147a and a second discharge port 147b by the third section 143. In addition, the slurry 5 discharged from the first discharge port 147a and the second discharge port 147b may be applied while being spaced apart by the width of the third section 143.

The third section 143 may be disposed to face the supply port 134. Therefore, the slurry 5 supplied from the supply port 134 may be distributed to both regions of the third section 143 and then discharged through the first discharge port 147a and the second discharge port 147b, respectively.

Meanwhile, the slurry 5 is supplied to the accommodating portion 132 through the supply port 134 and then discharged through the discharge port 147. However, as the supply port 134 is located in the center of the accommodating portion 132, discharge pressure of a portion of the discharge port 147 relatively close to the supply port 134 may be higher than discharge pressure of a portion relatively far from the supply port 134.

FIG. 4 is a cross-section of a metal foil coated with a slurry, and illustrates a cross-section taken along line II-II′ of FIG. 1, in which a) is a cross-section of the slurry applied through an electrode coating device without an expansion plate, and b) illustrates a cross-section of the slurry applied through an electrode coating device having an expansion plate.

Referring to FIG. 4, it can be seen that a discharged flow rate increases as it is closer to the supply port 134, and thus a variation occurs in the thickness of the slurry applied to the metal foil. In particular, referring to a) of FIG. 4, among both ends of the cross-section of the applied slurry 5, the thickness of the ends (the dotted line portion, ends formed by the third section) disposed in the center rapidly increases. This is determined to be caused by various factors, such as surface tension and pressure change.

Therefore, in consideration of the above problems, the electrode coating device 1 of the present embodiment may include an expansion plate 150.

The expansion plate 150 is provided to reduce a thickness variation of the slurry 5 by suppressing the flow rate of the portion in which the pressure is concentrated, and may be coupled to the shim plate 140.

The expansion plate 150 may be disposed in a form expanding the width of the third section 143 in a region corresponding to the accommodating portion 132. For example, the expansion plate 150 may be formed as a quadrangular plate and may be disposed in a form of reducing a space between the second section 142 and the third section 143 in the region corresponding to the accommodating portion 132.

In the present embodiment, the expansion plate 150 may be coupled to a portion in which the first section 141 is connected to the third section 143. Two expansion plates 150 may be respectively disposed on both sides of the third section 143, one of the sides of the expansion plate 150 may be in contact with the third section 143, and the other side thereof may be in contact with the first section 141.

When the expansion plate 150 is provided as in the present embodiment, as illustrated in b) of FIG. 4, it can be seen that the thickness variation at both ends is reduced in the cross-section of the applied slurry 5. In particular, it can be seen that the thickness does not increase rapidly but increases gradually at the end disposed in the center.

Therefore, the electrode coating device of the present embodiment may reduce the thickness variation of the slurry 5 applied to the current collector 3 by providing the expansion plate 150.

Meanwhile, if the size of the expansion plate 150 is excessively large, an appropriate amount of the slurry 5 may not be discharged. Accordingly, the size of the expansion plate 150 may be defined in consideration of the discharge amount of the slurry.

For example, considering a first direction, parallel to a length direction of the third section 143, if the width of the expansion plate 150 is excessively increased in the first direction, the size of the discharge port 147 may be reduced due to the expansion plate 150. Therefore, the expansion plate 150 of the present embodiment may be configured not to be disposed within the discharge port 147.

In addition, it was confirmed that the above effect does not appear clearly when a separation distance between the expansion plate 150 and the discharge port 147 in the first direction exceeds 4 mm. Therefore, a gap (D of FIG. 3 or the gap with the discharge port) between the side of the expansion plate 150 located to be adjacent to the discharge port 147, among the sides of the expansion plate 150, and an inner wall of the accommodating portion 132 may be formed to be 4 mm or less.

When the gap D is formed between the expansion plate 150 and the discharge port 147, a portion of the slurry 5 may be supplied to the discharge port 147 through the corresponding gap. In addition, when there is no gap D between the expansion plate 150 and the discharge port 147, the slurry 5 may entirely flow into the discharge port 147 in the region in which the expansion plate 150 is not present. In this case, the slurry 5 may be discharged while spreading toward the front of the expansion plate 150. However, if the width (W in FIG. 3) of the expansion plate 150 in a second direction is excessively large, the slurry 5 may not smoothly flow into the discharge port 147 adjacent to the third section 143, so the slurry 5 may not be properly applied to the current collector 3. Here, the second direction may be a direction parallel to the length direction of the first section 141.

The applicant of the present disclosure found that, when the width W of the expansion plate 150 exceeded 30 mm, the slurry 5 was not smoothly supplied to the discharge port 147 in front of the expansion plate 150 so the slurry 5 was not properly applied to the third section 143 side. In addition, it was confirmed that the effect described above does not clearly appear when the width W of the expansion plate 150 in the second direction is less than 5 mm.

Therefore, the expansion plate 150 of the present embodiment may have a width W in the second direction, that is, a length of the side contacting the first section 141, in a range of 5 mm to 30 mm.

The expansion plate 150 may be integrally manufactured with the shim plate 140 in the process of manufacturing the shim plate 140. However, the present disclosure is not limited thereto, and the expansion plate 150 may be manufactured separately from the shim plate 140 and then coupled to the shim plate 140. For example, the expansion plate 150 may be attached to the shim plate 140 through a welding method or an adhesive.

The electrode coating device 1 of the present embodiment configured as described above may reduce the thickness deviation of the slurry 5 by suppressing a flow rate of the portion in which the pressure is concentrated through the expansion plate 150, thereby securing manufacturing reliability.

Meanwhile, the electrode coating device 1 of the present disclosure is not limited to the embodiment described above and various modifications may be made.

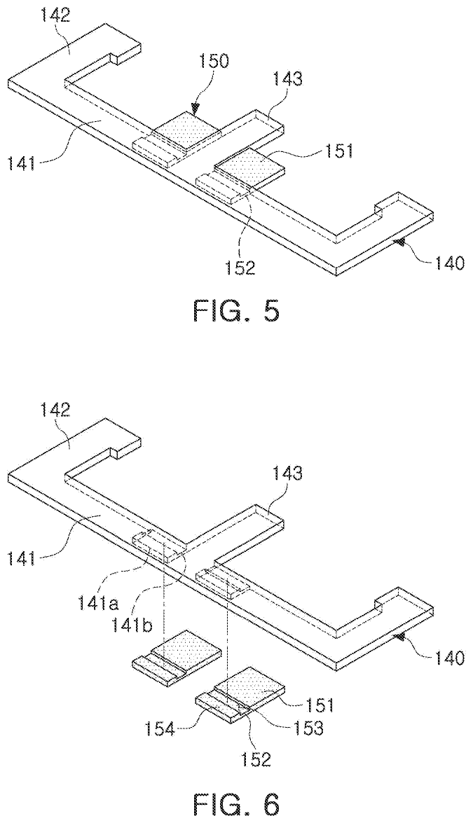

FIG. 5 is a partial cross-sectional view of an electrode coating device according to another embodiment of the present disclosure, and FIG. 6 is an exploded perspective view of the electrode coating device illustrated in FIG. 5.

Referring to FIGS. 5 and 6, in the electrode coating device 1 of the present embodiment, a portion of the expansion plate 150 may be disposed below the first section 141 and coupled to the first section 141.

To this end, the expansion plate 150 may include a flow control portion 151 disposed on the accommodating portion 132 and a coupling portion 152 extending from the flow control portion 151 to a lower portion of the shim plate 140.

Since the flow control portion 151 is configured to be similar to the expansion plate 150 of the embodiment described above, a detailed description thereof will be omitted.

The coupling portion 152 may include at least one first groove portion 153 and at least one first protrusion portion 154.

The first groove portion 153 may be disposed between the flow control portion 151 and the first protrusion portion 154 and may be formed to have a thickness less than that of the first protrusion portion 154 or the flow control portion 151. In addition, the first protrusion portion 154 may be disposed on the opposite side of the flow control portion 151 based on the first groove portion 153 and may be thicker than the first groove portion 153 and thinner than the flow control portion 151.

The coupling portion 152 may be entirely disposed below the shim plate 140. Accordingly, the coupling portion 152 may not be exposed or protrude to the outside of the shim plate 140.

At least one second groove portion 141a and at least one second protrusion portion 141b may be provided on a lower surface of the shim plate 140 to correspond to the shape of the coupling portion 152. In the present embodiment, the second groove portion 141a and the second protrusion portion 141b may be formed in the first section 141. However, the present disclosure is not limited thereto, and various modifications may be made such that the second groove portion 141a and the second protrusion portion 141b are formed in the third section 143 or may be formed in both the first section 141 and the third section 143 as in the embodiments described below.

The first protrusion portion 154 of the coupling portion 152 may be inserted into the second groove portion 141a. Accordingly, the second groove portion 141a may be formed as a groove corresponding to the size or thickness of the first protrusion portion 154. Also, the second protrusion portion 141b may be inserted into the first groove portion 153 of the coupling portion 152. Accordingly, the second protrusion portion 141b may protrude in a shape corresponding to the size or thickness of the first groove portion 153.

Like the coupling portion 152, the second groove portion 141a may be formed to have a thickness less than that of the second protrusion portion 141b or other portions of the first section 141. Also, the second protrusion portion 141b may be thicker than the second groove portion 141a and thinner than other portions of the first section 141.

Here, a total thickness of the first groove portion 153 and the second protrusion portion 141b may be equal to the thickness of other portions of the first section 141 or the flow control portion 151. Similarly, the total thickness of the second groove portion 141a and the first protrusion portion 154 may be equal to the thickness of other portions of the first section 141 or the flow control portion 151.

Through this configuration, the expansion plate 150 of the present embodiment may be coupled be engaged with the first section 141 of the shim plate 140. For example, the expansion plate 150 and the shim plate 140 may be coupled to each other by simply inserting the first protrusion portion 154 into the first groove portion 153 and the second protrusion portion 141b into the second groove portion 141a. Therefore, the expansion plate 150 and the shim plate 140 may be easily coupled to each other.

After being coupled to the shim plate 140, the expansion plate 150 of the present embodiment is pressed by the first die and the second die, so the expansion plate 150 may be stably fixed even without an adhesive. In this case, the expansion plate 150 may be detachably coupled to the shim plate 140. Therefore, in the electrode coating device 1 of the present embodiment, if the expansion plate 150 having a different size is required due to a change in viscosity, density, or flow rate of the slurry 5, the expansion plate 150 may be simply replaced.

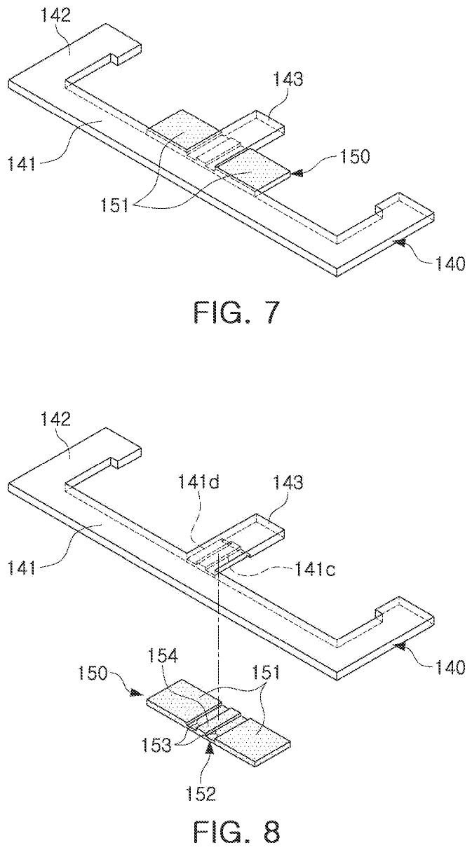

FIG. 7 is a perspective view of an electrode coating device according to another embodiment of the present disclosure, and FIG. 8 is an exploded perspective view of the electrode coating device illustrated in FIG. 7.

Referring to FIGS. 7 and 8, in the electrode coating device 1 of the present embodiment, the coupling portion 152 of the expansion plate 150 may be disposed below the third section 143 and coupled to the third section 143.

In the expansion plate 150 of the present embodiment, two flow control portions 151 may be disposed on both sides of the third session, respectively, and the coupling portion 152 may be disposed between the two flow control portions 151. Accordingly, the two flow control portions 151 may be connected to each other by the coupling portion 152 to be integrated.

The coupling portion 152 may include at least one first groove portion 153 and at least one first protrusion portion 154 similarly to the embodiment described above. Also, the third section 143 may include at least one third groove portion 141c and at least one third protrusion portion 141d on a lower surface thereof. The third groove portion and the third protrusion portion may be configured to be similar to the second groove portion 141a and the second protrusion portion 141b described above.

Through this configuration, in the electrode coating device 1 of the present embodiment, one expansion plate 150 may be coupled to the shim plate 140 to arrange the expansion plates 150 respectively on both sides of the third section 143. Accordingly, manufacturing may be facilitated and manufacturing costs may be reduced.

According to an embodiment of the present disclosure, since the thickness variation of the slurry is reduced by suppressing a flow rate of a portion in which pressure is concentrated through the expansion plate, manufacturing reliability may be secured.

According to an embodiment of the present document, since an overheated battery cell is detected or monitored using the thermochromic member, operator convenience for replacing a battery cell in which an event occurs may be improved. In addition, testing costs may be reduced and quality of the battery device may be improved.

Only specific examples of implementations of certain embodiments are described. Variations, improvements and enhancements of the disclosed embodiments and other embodiments may be made based on the disclosure of this patent document.

What is claimed is:

1. An electrode coating device comprising:
a die block including a first die and a second die coupled to each other, and at least one of the first die and the second die having an accommodating portion for accommodating slurry;
a shim plate partially disposed along a circumference of the accommodating portion between the first die and the second die to form a discharge port through which the slurry is discharged; and
an expansion plate coupled to the shim plate,
wherein the shim plate includes:
a first section disposed on the opposite side of the discharge port;
second sections extending from both ends of the first section toward the discharge port; and
a third section extending from a center of the first section toward the discharge port to divide the discharge port into a first discharge port and a second discharge port,
wherein the expansion plate is disposed in a form expanding a width of the third section in a region corresponding to the accommodating portion.

2. The electrode coating device of claim 1, wherein the expansion plate is disposed on both sides of the third section.

3. The electrode coating device of claim 1, wherein the expansion plate is formed of a square plate and is disposed such that one side thereof is in contact with the first section.

4. The electrode coating device of claim 3, wherein the expansion plate is disposed to be spaced apart from the discharge port by 4 mm or less.

5. The electrode coating device of claim 3, wherein the expansion plate is formed such that a length of the one side is in a range of 5 mm to 30 mm.

6. The electrode coating device of claim 1, further comprising:
a supply port formed through the die block and used as a path for supplying the slurry to the accommodating portion,
wherein the third section is disposed to face the supply port.

7. The electrode coating device of claim 1, wherein
the expansion plate includes a flow control portion disposed outside the shim plate and a coupling portion extending from the flow control portion and overlapping the shim plate,
the coupling portion includes at least one first groove portion and at least one first protrusion portion, and
the shim plate includes at least one second protrusion portion inserted into the at least one first groove portion and at least one second groove portion into which the at least one first protrusion portion is inserted.

8. The electrode coating device of claim 7, wherein the expansion plate is detachably coupled to the shim plate.

9. The electrode coating device of claim 7, wherein
the flow control portion is disposed on both sides of the third section, and
the coupling portion connects the two flow control portions and is coupled to the third section.

10. An electrode coating device comprising:
a die block including a first die and a second die coupled to each other, and at least one of the first die and the second die having an accommodating portion for accommodating slurry;
a shim plate partially disposed along a circumference of the accommodating portion between the first die and the second die to form a discharge port through which the slurry is discharged; and
an expansion plate coupled to the shim plate,
wherein the shim plate includes:
a first section disposed on the opposite side of the discharge port; and
a second section and a third section extending from the first section toward the discharge port, respectively, and
the expansion plate is disposed in a form of reducing a space between the second section and the third section in a region corresponding to the accommodating portion.

11. The electrode coating device of claim 10, further comprising:
a supply port formed through the die block and used as a path for supplying the slurry to the accommodating portion,
wherein the third section is disposed to face the supply port, and the expansion plate is disposed to be in contact with the third section.
